(19) United States
(12) Patent Application Publication
(10) Pub. No.: US 2026/0148680 A1
(43) Pub. Date: May 28, 2026

(54) DISPLAY DEVICE AND ELECTRONIC DEVICE

(71) Applicant: Samsung Display Co., Ltd., Yongin-Si (KR)

(72) Inventor: YOUNGSOO SOHN, Yongin-si (KR)

(21) Appl. No.: 19/218,368

(22) Filed: May 26, 2025

(30) Foreign Application Priority Data
Nov. 27, 2024 (KR) 10-2024-0171861

(51) Int. Cl. G09G 3/32

(52) U.S. Cl. CPC G09G 3/32; G09G 2300/0857; G09G 2310/08; G09G 2320/068; G09G 2330/021

(57) ABSTRACT

A display device includes a display panel including a plurality of pixels, and a display panel driver configured to drive the display panel. The plurality of pixels includes a first sub-pixel having a first viewing angle, and a second sub-pixel having a second viewing angle different from the first viewing angle. The first sub-pixel emits light based on a first sub-pixel compensation signal, and the second sub-pixel emits light based on a second sub-pixel compensation signal. The first sub-pixel compensation signal may be generated based on a first clock signal group, and the second sub-pixel compensation signal may be generated based on a second clock signal group. When the first sub-pixel emits light, the second clock signal group may maintain an inactivation level.

### CROSS-REFERENCE TO RELATED APPLICATION(S)

This application claims priority under 35 USC § 119 to Korean Patent Application No. 10-2024-0171861, filed on Nov. 27, 2024, in the Korean Intellectual Property Office, the content of which is herein incorporated by reference in its entirety.

### BACKGROUND

### 1. Field

Embodiments of the present inventive concept relate to a display device having a reduced power consumption and an electronic device including the display device.

### 2. Description of the Related Art

Generally, a display apparatus includes a display panel and a display panel driver. The display panel includes a plurality of gate lines, a plurality of data lines, a plurality of emission lines and a plurality of pixels. The display panel driver includes a gate driver providing a gate signal to the gate lines, a data driver providing a data voltage to the data lines, an emission driver providing an emission signal to the emission lines and a driving controller controlling the gate driver, the data driver and the emission driver.

Generally, a driving controller may generate a data signal for generating a data voltage based on a power signal and a clock signal.

### SUMMARY

Embodiments of the present inventive concept provide a display device having a reduced power consumption.

Embodiments of the present inventive concept also provide an electronic device having a reduced power consumption.

According to an embodiment of the present inventive concept, a display device includes a display panel including a plurality of pixels, and a display panel driver configured to drive the display panel. The plurality of pixels includes a first sub-pixel having a first viewing angle, and a second sub-pixel having a second viewing angle different from the first viewing angle. The first sub-pixel emits light based on a first sub-pixel compensation signal, and the second sub-pixel emits light based on a second sub-pixel compensation signal. The first sub-pixel compensation signal is generated based on a first clock signal group, and the second sub-pixel compensation signal is generated based on a second clock signal group. When the first sub-pixel emits light, the second clock signal group may maintain an inactivation level.

In an embodiment, the display panel driver may include a clock signal outputter configured to output the first clock signal group and the second clock signal group, a pixel compensator configured to output the first sub-pixel compensation signal and the second sub-pixel compensation signal based on an enable signal, and a power controller configured to apply a power signal to the pixel compensator.

In an embodiment, when the enable signal has an inactivation level, the pixel compensator may output the first sub-pixel compensation signal, and may not output the second sub-pixel compensation signal.

In an embodiment, when the enable signal has the inactivation level, the first clock signal group may toggle, and the second clock signal group may maintain the inactivation level.

In an embodiment, the pixel compensator may include a first pixel compensator configured to output the first sub-pixel compensation signal, and a second pixel compensator configured to output the second sub-pixel compensation signal. The power signal may include a first power signal applied to the first pixel compensator and a second power signal applied to the second pixel compensator. When the enable signal has the inactivation level, the first power signal may be applied to the first pixel compensator, and the second power signal may not be applied to the second pixel compensator.

In an embodiment, when the enable signal has an activation level, the first clock signal group may toggle, and the second clock signal group may toggle.

In an embodiment, the pixel compensator may include a first pixel compensator configured to output the first sub-pixel compensation signal, and a second pixel compensator configured to output the second sub-pixel compensation signal. The power signal may include a first power signal applied to the first pixel compensator and a second power signal applied to the second pixel compensator. When the enable signal has an activation level, the first power signal may be applied to the first pixel compensator, and the second power signal may be applied to the second pixel compensator.

In an embodiment, a first activation period in which the first clock signal group toggles may not overlap a second activation period in which the second clock signal group toggles.

In an embodiment, in the first activation period, the second clock signal group may maintain the inactivation level.

In an embodiment, the pixel compensator may include a first pixel compensator configured to output the first sub-pixel compensation signal, and a second pixel compensator configured to output the second sub-pixel compensation signal. The second pixel compensator may include a second pixel compensation signal outputter configured to output the second sub-pixel compensation signal, and a second pixel compensation data memory configured to apply second pixel compensation data to the second pixel compensation signal outputter. The second pixel compensation signal outputter may include a retention flip-flop performing a data retention.

In an embodiment, a frame period in which the display panel is driven may include a first frame period and a second frame period. The first frame period may include a first active period and a first blank period. The second frame period may include a second active period and a second blank period longer than the first blank period. In the second blank period, the first clock signal group and the second clock signal group may maintain the inactivation level.

According to an embodiment of the present inventive concept, a display device includes a display panel including a first display region and a second display region, and a display panel driver configured to drive the display panel. The first display region includes a first sub-pixel having a first viewing angle, and the second display region includes the first sub-pixel and a second sub-pixel having a second viewing angle different from the first viewing angle. The first sub-pixel emits light based on a first data signal, and the second sub-pixel emits light based on a second data signal. The first data signal is generated based on a first sub-pixel compensation signal, and the second data signal is generated based on a second sub-pixel compensation signal. The first sub-pixel compensation signal is generated based on a first clock signal group, and the second sub-pixel compensation signal is generated based on a second clock signal group. When the first sub-pixel of the second display region emits light, the second clock signal group maintains an inactivation level.

In an embodiment, the display panel driver may include a clock signal outputter configured to output the first clock signal group and the second clock signal group, a pixel compensator configured to output the first sub-pixel compensation signal and the second sub-pixel compensation signal based on an enable signal, and a power controller configured to apply a power signal to the pixel compensator.

In an embodiment, when the enable signal has an inactivation level, the first clock signal group may toggle, and the second clock signal group may maintain the inactivation level.

In an embodiment, when the enable signal has an activation level, the first clock signal group may toggle, and the second clock signal group may toggle.

In an embodiment, the display panel may be driven in a first mode or a second mode. In the first mode, the first sub-pixel of the second display region may emit light, and the second sub-pixel of the second display region may not emit light. In the second mode, the first sub-pixel of the second display region may not emit light, and the second sub-pixel of the second display region may emit light.

In an embodiment, when the display panel is driven in the first mode, the second clock signal group may maintain the inactivation level.

In an embodiment, when the display panel is driven in the first mode, a second power signal applied to a second sub-pixel compensator which outputs the second sub-pixel compensation signal may have an inactivation level.

According to an embodiment of the present inventive concept, an electronic device includes a processor configured to output input image data and an input control signal, a display panel including a plurality of pixels, and a display panel driver configured to drive the display panel based on the input image data and the input control signal, The plurality of pixels includes a first sub-pixel having a first view angle, and a second sub-pixel having a second viewing angle different from the first viewing angle. The first sub-pixel emits light based on a first sub-pixel compensation signal, and the second sub-pixel emits light based on a second sub-pixel compensation signal. The first sub-pixel compensation signal is generated based on a first clock signal group, and the second sub-pixel compensation signal is generated based on a second clock signal group. When the first sub-pixel emits light, the second clock signal group maintains an inactivation level.

In an embodiment, the display panel may include a first display region and a second display region. The first display region may include the first sub-pixel, and the second display region may include the first sub-pixel and the second sub-pixel. When the first sub-pixel of the second display region emits light, the second clock signal group may maintain the inactivation level.

As described above, based on an enable signal, output of a clock signal group and output of power signal may be controlled. Accordingly, a power consumption of a display device may be reduced.

Additionally, a driving controller may include a retention flip-flop and a retention memory. Accordingly, even when a power signal to the driving controller is shut down or off, pre-applied data may be maintained. Accordingly, a calculation speed of the driving controller may be improved. For example, a signal generation speed of the driving controller may be improved.

### BRIEF DESCRIPTION OF THE DRAWINGS

Illustrative, non-limiting embodiments will be more clearly understood from the following detailed description in conjunction with the accompanying drawings.

FIG. 1 is a block diagram illustrating a display device according to an embodiment of the present inventive concept.

FIG. 2 is a diagram illustrating a display panel included in a display device.

FIG. 3 is a block diagram illustrating a driving controller included in a display device.

FIG. 4 is a block diagram illustrating a public pixel compensator included in a driving controller of FIG. 3.

FIG. 5 a block diagram illustrating a private pixel compensator included in a driving controller of FIG. 3.

FIG. 6 is a timing diagram illustrating periods during which a driving controller of FIG. 3 is driven.

FIG. 7 is a timing diagram illustrating sub-periods included in a second period of FIG. 6.

FIG. 8 is a block diagram illustrating an operation of a driving controller of FIG. 3 during a first sub-period of FIG. 6.

FIG. 9 is a block diagram illustrating an operation of a driving controller of FIG. 3 during a second sub-period of FIG. 6.

FIG. 10 is a block diagram illustrating a frame period during which a display panel included in a display device of FIG. 1 is driven.

FIG. 11 is a timing diagram illustrating periods during which a driving controller of FIG. 3 is driven when a display panel of FIG. 1 is driven with a variable frequency.

FIG. 12 is a block diagram illustrating an operation of a driving controller of FIG. 3 during a second period of FIG. 11.

FIG. 13 is a block diagram illustrating a driving controller included in a display device of FIG. 1.

FIG. 14 is a timing diagram illustrating periods during which a driving controller of FIG. 13 is driven.

FIG. 15 is a diagram illustrating a display panel included in a display device of FIG. 1.

FIG. 16 is a block diagram illustrating an electronic device according to an embodiment of the present inventive concept.

FIG. 17 is a diagram illustrating an example in which the electronic device of FIG. 16 is implemented as an automotive electronic device.

### DETAILED DESCRIPTION OF THE INVENTIVE CONCEPT

Hereinafter, the present inventive concept will be explained in detail with reference to the accompanying drawings.

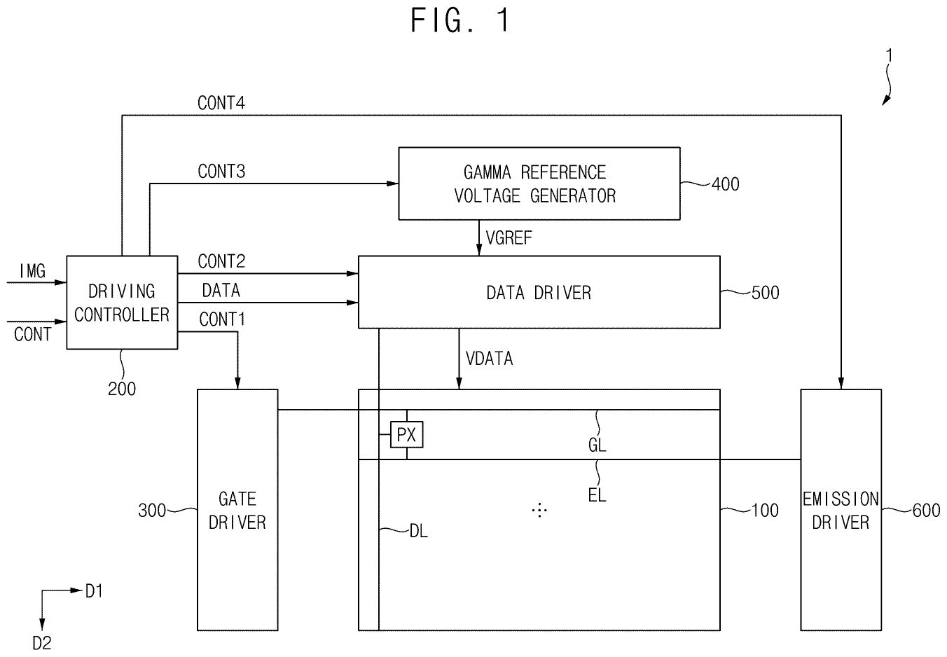

FIG. 1 is a block diagram illustrating a display device 1 according to an embodiment of the present inventive concept.

Referring to FIG. 1, the display device 1 may include a display panel 100 and a display panel driver. The display panel driver may include a driving controller 200, a gate driver 300, a gamma reference voltage generator 400, a data driver 500, and an emission driver 600.

The display panel 100 may have a display region which displays an image and a peripheral region placed adjacent to the display region.

The display panel 100 may include a plurality of gate lines GL, a plurality of data lines DL, a plurality of emission lines EL and a plurality of pixel PX each of which is electrically connected to a corresponding gate line, a corresponding data line and a corresponding emission line among the plurality of gate lines GL, the plurality of data lines DL and the plurality of emission lines EL, respectively. The gate lines GL may extend in a first direction D1. The data lines DL may extend in a second direction D2 crossing the first direction D1. The emission lines EK may extend in the first direction D1.

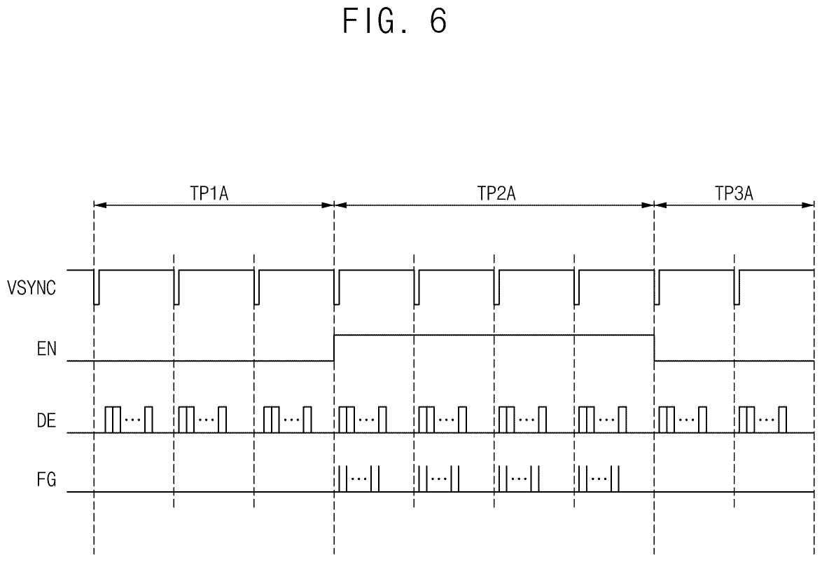

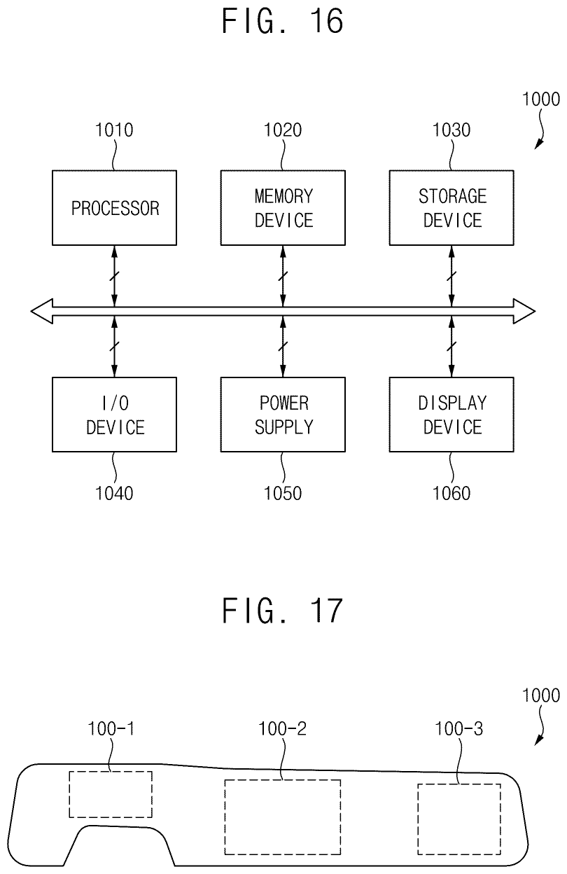

The driving controller 200 may receive input image data IMG and an input control signal CONT from an external device (e.g., from a processor 1010 in FIG. 16). For example, the input image data IMG may include red image data, green image data and blue image data. The input image data IMG may include white image data. The input image data IMG may include magenta image data, cyan image data and yellow image data. For example, the input control signal CONT may include a master clock signal and a data enable signal DE (see FIG. 6). The input control signal CONT may further include a vertical synchronizing signal VSYNC of FIG. 6 and a horizontal synchronizing signal. The input control signal CONT may further include an enable signal EN and a flag signal FG (see FIG. 6).

The driving controller 200 may generate a first control signal CONT1, a second control signal CONT2, a third control signal CONT3, a fourth control signal CONT4 and a data signal DATA based on the input image data IMG and the input control signal CONT.

The driving controller 200 may generate the first control signal CONT1 for controlling an operation of the gate driver 300 based on the input control signal CONT, and output the first control signal CONT1 to the gate driver 300. For example, the first control signal CONT1 may include a vertical start signal and a gate clock signal.

The driving controller 200 may generate the second control signal CONT2 for controlling an operation of the data driver 500 based on the input control signal CONT, and output the second control signal CONT2 to the data driver 500. For example, the second control signal CONT2 may include a horizontal start signal and a load signal.

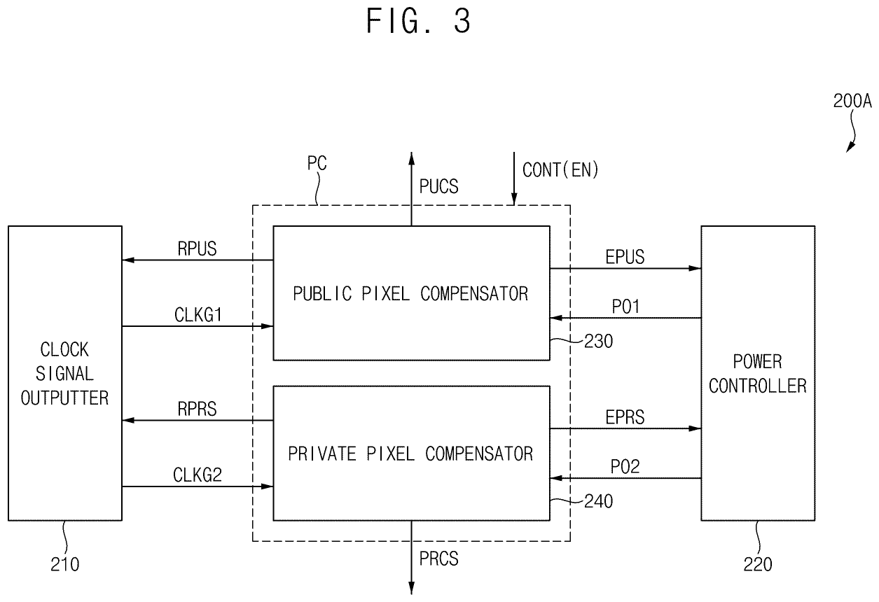

The driving controller 200 may generate the data signal DATA based on the input image data IMG. The driving controller 200 may output the data signal DATA to the data driver 500. The data signal DATA may include public pixel data signal PUCS and a private pixel data signal PRCS (see FIG. 3).

The driving controller 200 may generate the third control signal CONT3 for controlling an operation of the gamma reference voltage generator 400 based on the input control signal CONT, and output the third control signal CONT3 to the gamma reference voltage generator 400.

The driving controller may generate the fourth control signal CONT4 for controlling an operation of the emission driver 600 based on the input control signal CONT, and output the fourth control signal CONT4 to the emission driver 600.

The gate driver 300 may generate gate signals which are provided to the plurality of pixels PX in response to the first control signal CONT1 received from the driving controller 200. The gate driver 300 may output the gate signals to the gate lines GL.

In an embodiment, the gate driver 300 may be disposed in the peripheral region. In an embodiment, the gate driver 300 may be integrated in the peripheral region.

The gamma reference voltage generator 400 may generate a gamma reference voltage VGREF in response to the third control signal CONT3 received from the driving controller 200. The gamma reference voltage generator 400 may provide the gamma reference voltage VGREF to the data driver 500. The gamma reference voltage VGREF may have a value corresponding to a level of the data signal DATA.

In an embodiment, the gamma reference voltage generator 400 may be disposed in the driving controller 200, or in the data driver 500.

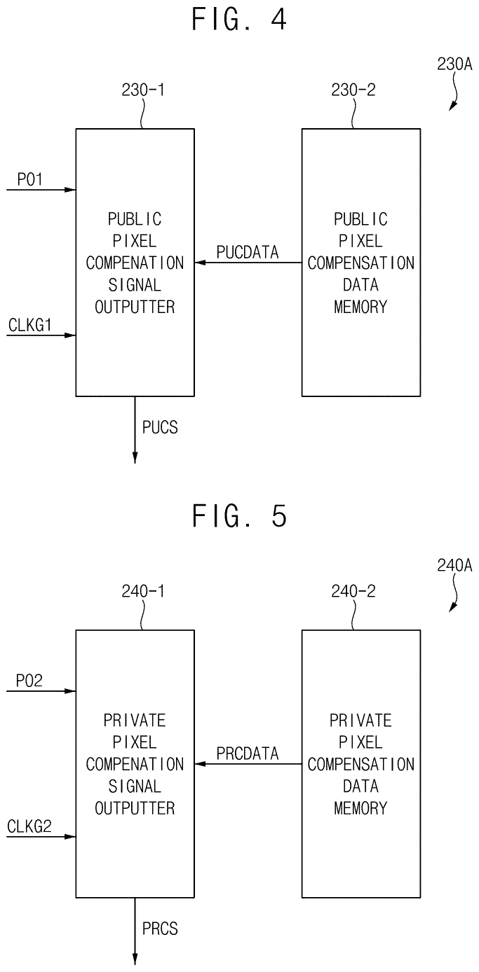

The data driver 500 may receive the second control signal CONT2 and the data signal DATA from the driving controller 200, and receive the gamma reference voltage VGREF from the gamma reference voltage generator 400. The data driver 500 may convert the data signal DATA into data voltages VDATA having an analog type using the gamma reference voltages VGREF. The data voltages having an analog type may be a pixel data voltage PVDATA (see FIG. 4). The pixel data voltage PVDATA of FIG. 4 may be a voltage corresponding to the data signal DATA. The data driver 500 may output the data voltages VDATA to the data lines DL.

In an embodiment, the data driver 500 may be disposed in the peripheral region. In an embodiment, the data driver 500 may be integrated in the peripheral region.

The emission driver 600 may generate an emission signal in response to the fourth control signal CONT4 received from the driving controller 200. The emission driver 600 may output the emission signal to the display panel 100. The emission driver 600 may generate the emission signal based on a driving voltage DV. For example, the driving voltage DV may include an emission high voltage and an emission low voltage. The emission signal EM may toggle between the emission high voltage and the emission low voltage.

In an embodiment, the emission driver 600 may be disposed in the peripheral region. In an embodiment, the emission driver 600 may be integrated on the peripheral region.

Although FIG. 1 illustrates that the gate driver 300 is disposed on a first side of the display panel 100 and the emission driver 600 is disposed on a second side of the display panel 100 for convenience of explanation, the present inventive concept is not limited thereto. The gate driver 300 and the emission driver 600 may be disposed on the first side of the display panel 100. For example, the gate driver 300 and the emission driver 600 may be disposed on the peripheral region of the display panel 100 on the same side of the display region of the display panel 100. For example, the gate driver 300 and the emission driver 600 may be formed integrally with each other.

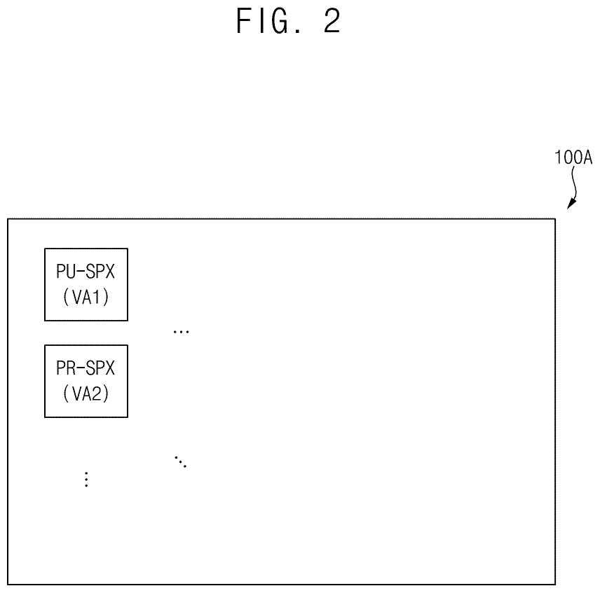

FIG. 2 is a diagram illustrating a display panel 100A included in a display device 1 of FIG. 1.

Referring to FIG. 1 and FIG. 2, a display panel 100A may include the plurality of pixels PX. The pixels PX may include a first sub-pixel PU-SPX and a second sub-pixel PR-SPX. The first sub-pixel PU-SPX may include a light emitting element having a first viewing angle VA1. The second sub-pixel PR-SPX may include a light emitting element having a second viewing angle VA2. The first viewing angle VA1 may be different from the second viewing angle VA2. For example, the first viewing angle VA1 may be wider than the second viewing angle VA2. For example, the first sub-pixel PU-SPX may be called as a public sub-pixel. For example, the second sub-pixel PR-SPX may be called as a private sub-pixel.

In an embodiment, the first sub-pixel PU-SPX may include a first red sub-pixel emitting light of a red color, a first green sub-pixel emitting light of a green color and a first blue sub-pixel emitting light of a blue color. However, the present inventive concept is not limited to the number of sub-pixels included in the first sub-pixel PU-SPX as described above. Additionally, the present inventive concept is not limited to a color of each sub-pixels included in the first sub-pixel PU-SPX as described above.

In an embodiment, the second sub-pixel PR-SPX may include a second red sub-pixel emitting light of a red color, a second green sub-pixel emitting light of a green color and a second blue sub-pixel emitting light of a blue color. However, the present inventive concept is not limited to the number of sub-pixels included in the second sub-pixel PR-SPX as described above. Additionally, the present inventive concept is not limited to the color of each sub-pixels included in the second sub-pixel PR-SPX as described above.

In an embodiment, each size of the second red sub-pixel, the second green sub-pixel and the second blue sub-pixel may be same as or smaller than each size of the first red sub-pixel, the first green sub-pixel and the first blue sub-pixel.

FIG. 3 is a block diagram illustrating an example of a driving controller 200 included in a display device 1. FIG. 4 is a block diagram illustrating a public pixel compensator 230 included in a driving controller 200A of FIG. 3. FIG. 5 a block diagram illustrating a private pixel compensator 240 included in a driving controller 200A of FIG. 3.

Referring to FIG. 1 to FIG. 5, a driving controller 200A may include a clock signal outputter 210, a power controller 220 and a pixel compensator PC.

The clock signal outputter 210 may output a first clock signal group CLKG1 and a second clock signal group CLKG2. The clock signal outputter 210 may output the first clock signal group CLKG1 in response to the public pixel clock signal request signal RPUS. The clock signal outputter 210 may output the second clock signal group CLKG2 in response to the private pixel clock signal request signal RPRS. The first clock signal group CLKG1 may include a plurality of clock signals. The second clock signal group CLKG2 may include a plurality of clock signals. The clock signals may toggle between a clock high level and a clock low level. For example, clock signals may periodically transition between the clock high level and the clock low level.

The power controller 220 may output a first power signal PO1 and a second power signal PO2. The power controller 220 may output the first power signal PO1 in response to a public pixel power request signal EPUS. The power controller 220 may output the second power signal PO2 in response to the private pixel power request signal EPRS. The first power signal PO1 may have an activation level or an inactivation level. The first power signal PO1 having an activation level may turn on the public pixel compensator 230. The first power signal PO1 having an inactivation level may turn off the public pixel compensator 230. The second power signal PO2 having an activation level may turn on the private pixel compensator 240, and the second power signal PO2 having an inactivation level may turn off the private pixel compensator 240.

The pixel compensator PC may generate a compensated data signal in which the input image data IMG is compensated. For example, the input image data IMG is compensated based on a stage of the display panel 100A. For example, the stage of the display panel 100A may include an information regarding a deterioration, a characteristic of a manufacturing process, a driving time, and etc. of the display panel 100A. The driving controller 200A may perform a compensation operation for compensating the display panel 100A. For example, the compensation operation may include a calculation operation, a compensation data load operation, a deterioration data receiving operation, a grayscale data load operation and a grayscale data calculation operation, and etc. The calculation operation may mean an operation of converting a grayscale of the input image data IMG. The compensation data load operation may mean an operation of receiving data for converting the grayscale from a non-volatile memory. The deterioration data receiving operation may mean an operation of receiving data regarding a deterioration and a driving time of the display panel 100A from a stress convertor for converting the grayscale based on the received data. The grayscale data load operation may mean an operation of receiving grayscale data corresponding to the characteristic of the manufacturing process of the display panel 100A. The grayscale data calculation operation may mean a calculation operation for converting a grayscale of the input image data IMG based on the grayscale data. The pixel compensator PC may perform the compensation operation based on the enable signal EN.

The pixel compensator PC may include a public pixel compensator 230 and a private pixel compensator 240.

The public pixel compensator 230 may output the public pixel clock request signal RPUS and the public pixel power request signal EPUS based on the enable signal EN. The public pixel compensator 230 may receive the first clock signal group CLKG1 and the first power signal PO1. The public pixel compensator 230 may perform the compensation operation based on the first clock signal group CLKG1 and the first power signal PO1. The public pixel compensator 230 may perform the compensation operation for the first sub-pixel PU-SPX based on the first clock signal group CLKG1 and the first power signal PO1. The public pixel compensator 230 may output the public pixel data signal PUCS which reflects the compensation operation of the public pixel compensator 230. For example, the public pixel data signal PUCS may be called as a first sub-pixel compensation signal. The first sub-pixel PU-SPX may emit light based on the public pixel data signal PUCS.

In an embodiment, a public pixel compensator 230A may include a public pixel compensation signal outputter 230-1 and a public pixel compensation data memory 230-2. The public pixel compensation signal outputter 230-1 may receive the first power signal PO1, the first clock signal group CLKG1 and public pixel compensation data PUCDATA. The public pixel compensation data PUCDATA may include data for performing the compensation operation. For example, the public pixel compensation data PUCDATA may include data for performing the compensation operation to the first sub-pixel PU-SPX. For example, the public pixel compensation data PUCDATA may include a plurality of gamma voltage lookup tables corresponding to preset luminance. The public pixel compensation signal outputter 230-1 may include a retention flip-flop. The retention flip-flop may perform a data retention. The retention flip-flop may store received data even when power is not applied. The public pixel compensation data memory 230-2 may be the retention memory. The retention memory may store data even when power is not applied.

The private pixel compensator 240 may output the private pixel clock request signal RPRS and the private pixel power request signal EPRS based on the enable signal EN. When the enable signal EN has an activation level, the private pixel compensator 240 may output the private pixel clock request signal RPRS and the private pixel power request signal EPRS. The private pixel compensator 240 may receive the second clock signal group CLKG2 and the second power signal PO2. The private pixel compensator 240 may perform the compensation operation based on the second clock signal group CLKG2 and the second power signal PO2. The private pixel compensator 240 may perform the compensation operation for the second sub-pixel PR-SPX based on the second clock signal group CLKG2 and the second power signal PO2. The private pixel compensator 240 may output the private pixel data signal PRCS which reflects the compensation operation of the private pixel compensator 240. For example, the private pixel data signal PRCS may be called as a second sub-pixel compensation signal. The second sub-pixel PR-SPX may emit light based on the private pixel data signal PRCS.

In an embodiment, a private pixel compensator 240A may include a private pixel compensation signal outputter 240-1 and a private pixel compensation data memory 240-2. The private pixel compensation signal outputter 240-1 may receive the second power signal PO2, the second clock signal group CLKG2 and private pixel compensation data PRCDATA. The private pixel compensation data PRCDATA may include data for performing the compensation operation. For example, the private pixel compensation data PRCDATA may include data for performing the compensation operation to the second sub-pixel PR-SPX. For example, the private pixel compensation data PRCDATA may include a plurality of gamma voltage lookup tables corresponding to preset luminance. The private pixel compensation signal outputter 240-1 may include a retention flip-flop. The private pixel compensation data memory 240-2 may be the retention memory.

In an embodiment, the public pixel compensator 230A and/or the private pixel compensator 240A may include the retention flip-flop and the retention memory. The public pixel compensator 230A and/or the private pixel compensator 240A may include the retention flip-flop and the retention memory, such that the public pixel compensator 230A and/or the private pixel compensator 240A may keep the pre-received data even if the power applied to the public pixel compensator 230A and/or the private pixel compensator 240A is shut down or interrupted. Accordingly, a calculation speed of the public pixel compensator 230A and/or the private pixel compensator 240A may be improved. Accordingly, a signal generation speed of the public pixel compensator 230A and/or the private pixel compensator 240A may be improved.

In other words, if the public pixel compensator 230A and/or the private pixel compensator 240A does not include the retention flip-flop, and if the public pixel compensator 230A and/or the private pixel compensator 240A is powered off, the data stored in the public pixel compensator 230A and/or the private pixel compensator 240A may be deleted. Accordingly, if the public pixel compensator 230A and/or the private pixel compensator 240A is powered on, it may be necessary to load data (e.g., calculation parameters and a lookup table) from the flash memory. Accordingly, while the display device 1 is operated, the public pixel compensator 230A and/or the private pixel compensator 240A may not perform power-on and power-off operations in real time. In contrast, as the public pixel compensator 230A and/or the private pixel compensator 240A according to an embodiment of the present inventive concept may include the retention flip-flop and the retention memory, the pre-received data may be maintained even if the public pixel compensator 230A and/or the private pixel compensator 240A is powered off. Accordingly, the public pixel compensator 230A and/or the private pixel compensator 240A may perform power-on and power-off operations in real time.

FIG. 6 is a timing diagram illustrating periods during which a driving controller 200A of FIG. 3 is driven.

Referring to FIG. 1 to FIG. 6, periods during which the display panel 100A is driven may include first to third periods TP1A, TP2A and TP3A.

In the first period TP1A, the vertical synchronizing signal VSYNC may have an activation level. In the first period TP1A, the vertical synchronizing signal VSYNC may toggle between an activation level and an inactivation level. When the vertical synchronizing signal VSYNC has an activation level, the gate signals may be generated.

In the first period TP1A, the data enable signal DE may have an activation level. When the data enable signal DE has an activation level, the data voltage VDATA may be applied to the display panel 100A. For example, when the data enable signa DE has an activation level, the data voltage VDATA may be applied to the pixel PX.

In an embodiment of the present inventive concept, the data voltage VDATA may be applied to the second sub-pixel PR-SPX based on a flag signal FG. An emission of the second sub-pixel PR-SPX may be controlled based on the flag signal FG. For example, when the flag signal FG has an activation level, the data voltage VDATA may be applied to the second sub-pixel PR-SPX. For example, when the flag signal FG has an inactivation level, applying of the data voltage VDATA to the second sub-pixel PR-SPX may be stopped. When the flag signal FG has an inactivation level, the second sub-pixel PR-SPX may stop emitting light based on the data voltage VDATA.

In the first period TP1A, the flag signal FG may have an inactivation level. When the flag signal FG has an inactivation level, the second sub-pixel PR-SPX may not receive the data voltage VDATA. For example, when the flag signal FG has an inactivation level, the data voltage VDATA may not be applied to the second sub-pixel PR-SPX.

In the first period TP1A, the enable signal EN may have an inactivation level. In the first period TP1A, as the enable signal EN may have an inactivation level, the private pixel compensator 240 may not receive the second clock signal group CLKG2 and the second power signal PO2. In the first period TP1A, as the enable signal EN may have an inactivation level, only first sub-pixels PU-SPX may be driven. Accordingly, the private pixel compensator 240 may stop receiving the second clock signal group CLKG2 and the second power signal PO2. In the first period TP1A, as the enable signal EN may have an inactivation level, the compensation operation for the second sub-pixel PR-SPX may not be performed. Additionally, in the first period TP1A, as the enable signal EN may have an inactivation level, a generation of the private pixel data signal PRCS may be stopped.

In the second period TP2A, the vertical synchronizing signal VSYNC may have an activation level. For example, in the second period TP2A, the vertical synchronizing signal VSYNC may toggle between an activation level and an inactivation level. In the second period TP2A, the data enable signal DE may have an activation level. In the second period TP2A, the flag signal FG may have an activation level. When the flag signal FG has an activation level, the data voltage VDATA may be applied to the second sub-pixel PR-SPX. In the second period TP2A, the enable signal EN may have an activation level. In the second period TP2A, as the enable signal EN may have an activation level, the private pixel compensator 240 may receive the second clock signal group CLKG2 and the second power signal PO2. In the second period TP2A, as the enable signal EN may have an activation level, the compensation operation for the second sub-pixel PR-SPX may be performed. In the second period TP2A, as the enable signal EN may have an activation level, the private pixel data signal PRCS may be generated.

In the third period TP3A, the vertical synchronizing signal VSYNC may have an activation level. For example, in the third period TP3A, the vertical synchronizing signal VSYNC may toggle between an activation level and an inactivation level. In the third period TP3A, the data enable signal DE may have an activation level. In the third period TP3A, the flag signal FG may have an inactivation level. In the third period TP3A, the enable signal EN may have an inactivation level. In the third period TP3A, as the enable signal EN may have an inactivation level, the private pixel compensator 240 may not receive the second clock signal group CLKG2 and the second power signal PO2. In the third period TP3A, as the enable signal EN may have an inactivation level, the compensation operation for the second sub-pixel PR-SPX may not be performed. In the third period TP3A, as the enable signal EN may have an inactivation level, a generation of the private pixel data signal PRCS may be stopped.

In an embodiment of the present inventive concept, based on the enable signal EN, output of the second clock signal group CLKG2 and output of the second power signal PO2 may be controlled. Accordingly, a power consumption of the display device 1 may be reduced.

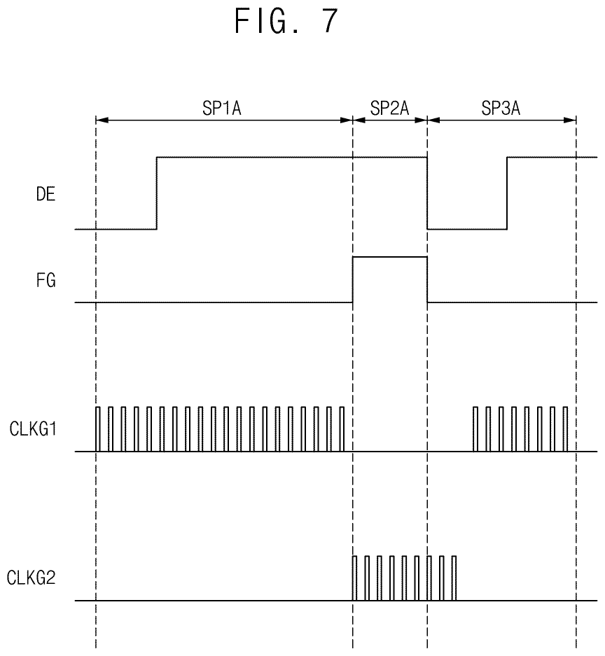

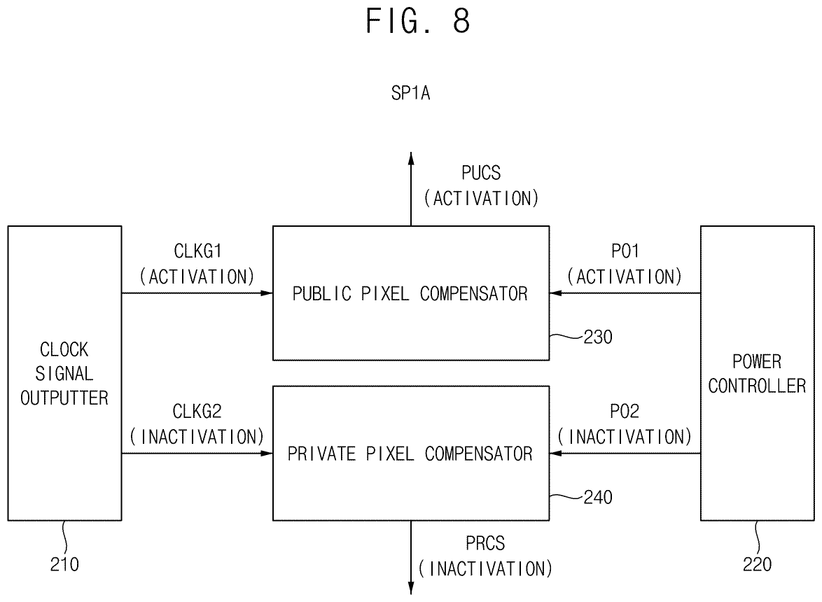

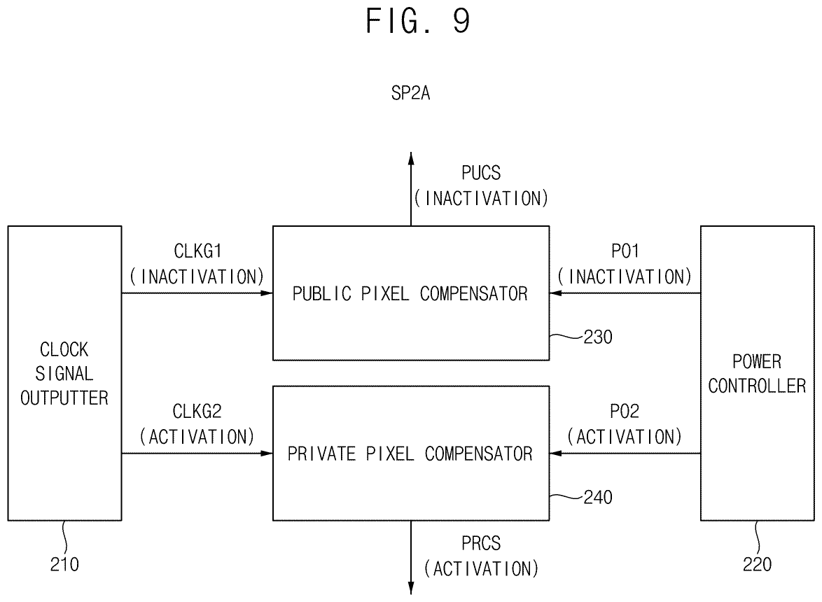

FIG. 7 is a timing diagram illustrating sub-periods SP1A, SP2A and SP3A included in a second period TP2A of FIG. 6. FIG. 8 is a block diagram illustrating an operation of a driving controller 200A of FIG. 3 during a first sub-period SP1A. FIG. 9 is a block diagram illustrating an operation of a driving controller 200A of FIG. 3 during a second sub-period SP2A.

Referring to FIG. 1 to FIG. 9, the second period TP2A may include first to third sub-periods SP1A, SP2A and SP3A.

In the first sub-period SP1A, the data enable signal DE may have an activation level. In the first sub-period SP1A, the flag signal FG may have an inactivation level. In the first sub-period SP1A, the first clock signal group CLKG1 may toggle. In the first sub-period SP1A, the second clock signal group CLKG2 may not toggle. For example, in the first sub-period SP1A, the second clock signal group CLKG2 may maintain a DC voltage to have an inactivation level. For example, the first sub-period SP1A, a period during which the first clock signal group CLKG1 toggles may be called as a first activation period.

In the first sub-period SP1A, the data enable signal DE may have an activation level. As the data enable signal DE may have an activation level during the first sub-period SP1A, the public pixel clock request signal RPUS and the public pixel power request signal EPUS may have an activation level. As the public pixel clock request signal RPUS and the public pixel power request signal EPUS may have an activation level, the public pixel compensator 230 may receive the first clock signal group CLKG1 and the first power signal PO1. Accordingly, the public pixel compensator 230 may perform the compensation operation for the first sub-pixel PU-SPX. Additionally, the public pixel compensator 230 may output the public pixel data signal PUCS.

In the first sub-period SP1A, the flag signal FG may have an inactivation level. As the flag signal FG may have an inactivation level, the private pixel clock request signal RPRS and the private pixel power request signal EPRS may have an inactivation level. As the private pixel clock request signal RPRS and the private pixel power request signal EPRS may have an inactivation level, the private pixel compensator 240 may stop receiving the second clock signal group CLKG2 and the second power signal PO2. For example, the private pixel compensator 240 may not receive the second clock signal group CLKG2 and the second power signal PO2. Accordingly, the private pixel compensator 240 may stop performing the compensation operation for the second sub-pixel PR-SPX during the first sub-period SP1A. Additionally, the private pixel compensator 240 may stop outputting the private pixel data signal PRCS during the first sub-period SP1A.

In the second sub-period SP2A, the data enable signal DE may have an activation level. In the second sub-period SP2A, the flag signal FG may have an activation level. In the second sub-period SP2A, the first clock signal group CLKG1 may stop toggling. For example, in the second sub-period SP2A, the first clock signal group CLKG1 may maintain a DC voltage to have an inactivation level. In the second sub-period SP2A, the second clock signal group CLKG2 may toggle. For example, in the second sub-period SP2A, a period during which the second clock signal group CLKG2 toggles may be called as a second activation period.

In the second sub-period SP2A, the flag signal FG may have an activation level. As the flag signal FG may have an activation level, the public pixel clock request signal RPUS and the public pixel power request signal EPUS may have an inactivation level. As the public pixel clock request signal RPUS and the public pixel power request signal EPUS may have an inactivation level, the public pixel compensator 230 may stop receiving the first clock signal group CLKG1 and the first power signal PO1. Accordingly, the public pixel compensator 230 may stop performing the compensation operation for the first sub-pixel PU-SPX during the second sub-period SP2A. Additionally, the public pixel compensator 230 may stop outputting the public pixel data signal PUCS during the second sub-period SP2A.

In the second sub-period SP2A, the flag signal FG may have an activation level. As the flag signal FG may have an activation level, the private pixel clock request signal RPRS and the private pixel power request signal EPRS may have an activation level. As the private pixel clock request signal RPRS and the private pixel power request signal EPRS may have an activation level, the private pixel compensator 240 may receive the second clock signal group CLKG2 and the second sub-pixel PR-SPX. Accordingly, the private pixel compensator 240 may perform the compensation operation on the second sub-pixel PR-SPX during the second sub-period SP2A. Additionally, the private pixel compensator 240 may output the private pixel data signal PRCS during the second sub-period SP2A.

In the third sub-period SP3A, the data enable signal DE may have an activation level. In the third sub-period SP3A, the flag signal FG may have an inactivation level. In the third sub-period SP3A, the first clock signal group CLKG1 may toggle. For example, in the third sub-period SP3A, the second clock signal group CLKG2 may not toggle. For example, in the third sub-period SP3A, the second clock signal group CLKG2 may maintain a DC voltage to have an inactivation level. In an embodiment, the compensation operation for the first sub-pixel PU-SPX may be performed until a period when the flag signal FG turns an active level again.

In an embodiment of the present inventive concept, in the first activation period, the second clock signal group CLKG2 may maintain a DC voltage to have an inactivation level. In contrast, in the second activation period, the first clock signal group CLKG1 may maintain a DC voltage to have an inactivation level. For example, the first activation period and the second activation period may not overlap. As the first activation period and the second activation period may not overlap, a period in which the compensation operation for the first sub-pixel PU-SPX is performed and a period in which the compensation operation for the second sub-pixel PR-SPX is performed may not overlap. Accordingly, a reliability of the compensation operation may be improved.

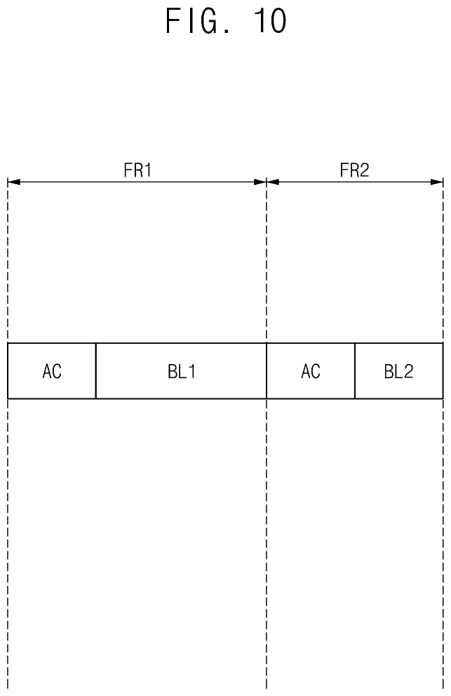

FIG. 10 is a block diagram illustrating a frame period in which a display panel 100A included in a display device 1 of FIG. 1 is driven.

Referring to FIG. 1 to FIG. 10, the display panel 100 may be driven as a variable frequency. A first frame period FR1 may include an active period AC and a first blank period BL1. In the active period AC, the data voltage VDATA may be applied to the pixels PX. For example, a start of the active period AC may be synchronized with the vertical synchronizing signal VSYNC. In the first blank period BL1, an operation of applying the data voltage VDATA to the pixels PX may be stopped. The second frame period FR2 may include the active period AC and the second blank period BL2. In the second blank period BL2, the operation of applying the data voltage VDATA to the pixels PX may be stopped. A length of the first blank period BL1 and a length of the second blank period BL2 may be different. For example, when the first frame period FR1 is driven as a first driving frequency, and the second frame period FR2 is driven as a second driving frequency higher than the first driving frequency, a length of the first blank period BL1 may be longer than a length of the second blank period BL2.

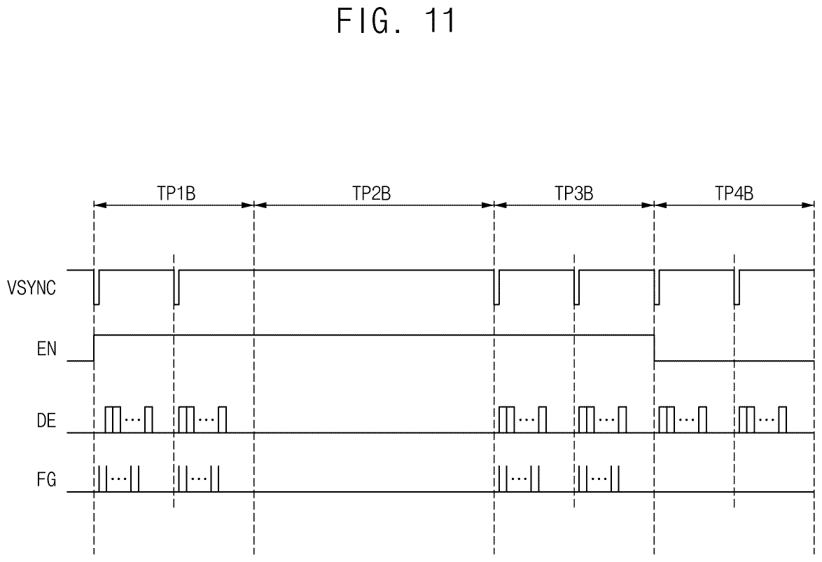

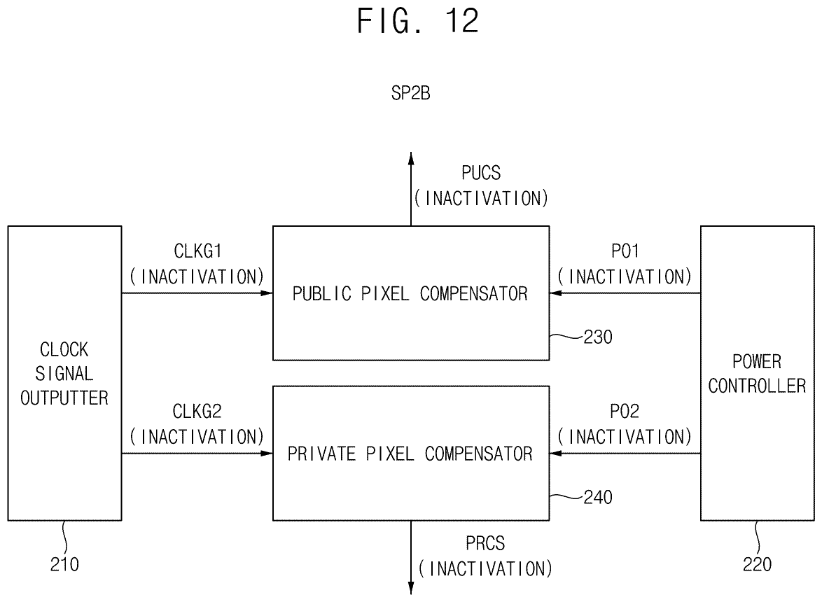

FIG. 11 is a timing diagram illustrating periods during which a driving controller 200A of FIG. 3 is driven when a display panel 100A of FIG. 1 is driven with a variable frequency. FIG. 12 is a block diagram illustrating an operation of a driving controller 200A of FIG. 3 during a second period TP2B of FIG. 11.

Referring to FIG. 1 to FIG. 12, periods during which the display panel 100A is driven with a variable frequency may include first to fourth periods TP1B, TP2B, TP3B and TP4B.

In the first period TP1B, the vertical synchronizing signal VSYNC may have an activation level. In the first period TP1B, the enable signal EN may have an activation level. In the first period TP1B, the data enable signal DE may have an activation level. In the first period TP1B, the flag signal FG may have an activation level.

In the first period TP1B, as the enable signal EN, the data enable signal DE and the flag signal FG may have an activation level, the public pixel data signal PUCS and the private pixel data signa PRCS may be generated.

In the second period TP2B, a length of the blank period may be increased. In the second period TP2B, the enable signal EN may have an activation level. In the second period TP2B, the data enable signal DE may maintain an inactivation level. In the second period TP2B, the flag signal FG may maintain an inactivation level. The second period TP2B may correspond to the first blank period BL1 and/or the second blank period BL2.

In the second period TP2B, as the length of the blank period may be increased, and the data enable signal DE and the flag signal FG may have an inactivation level, a generation of the public pixel data signal PUCS and the private pixel data signa PRCS may be stopped.

In the third period TP3B, the vertical synchronizing signal VSYNC may have an activation level. In the third period TP3B, the enable signal EN may have an activation level. In the third period TP3B, the data enable signal DE may have an activation level. In the third period TP3B, the flag signal FG may have an activation level.

In the third period TP3B, as the enable signal EN, the data enable signal DE and the flag signal FG may have an activation level, t the public pixel data signal PUCS and the private pixel data signa PRCS may be generated.

In the fourth period TP4B, the vertical synchronizing signal VSYNC may have an activation level. In the fourth period TP4B, the enable signal EN may have an inactivation level. In the fourth period TP4B, the data enable signal DE may have an activation level. In the fourth period TP4B, the flag signal FG may have an inactivation level.

In the fourth period TP4B, as the enable signal EN and the flag signal FG may have an inactivation level, a generation of the private pixel data signal PRCS may be stopped. In the fourth period TP4B, as the data enable signal DE may have an activation level, the public pixel data signal PUCS may be generated.

In an embodiment of the present inventive concept, a generation of the public pixel data signal PUCS and the private pixel data signa PRCS may be controlled. Additionally, when the display panel 100 is driven as a variable frequency, a generation of the public pixel data signal PUCS and the private pixel data signa PRCS may be controlled based on a low frequency period (e.g., a length of the blank period). For example, an output of the first clock signal group CLKG1 and an output of the second clock signal group CLKG2 may be controlled in response to the vertical synchronizing signal VSYNC. Accordingly, a power consumption of the display device 1 may be further reduced.

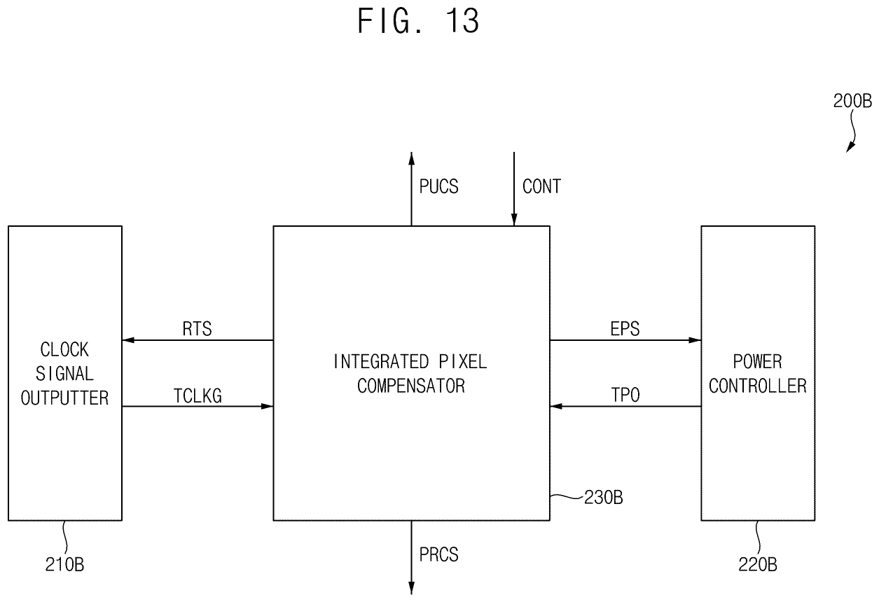

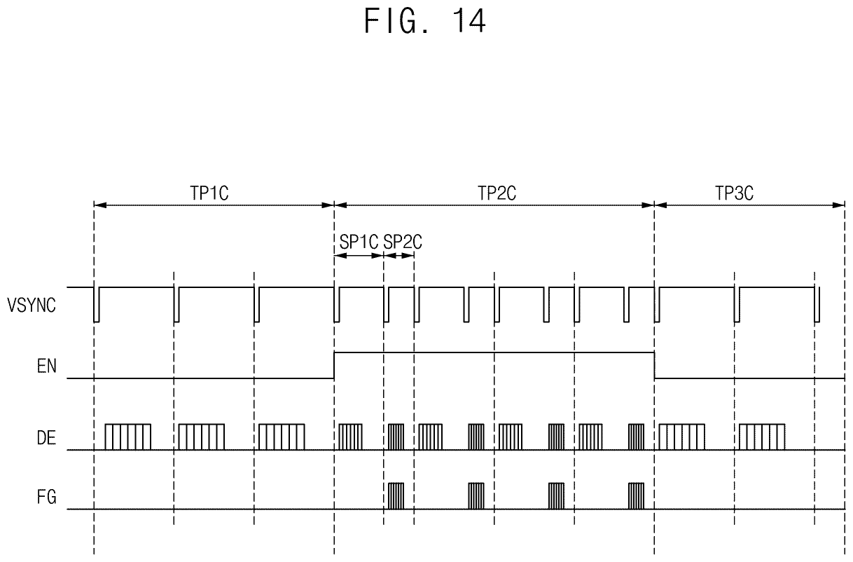

FIG. 13 is a block diagram illustrating a driving controller 200 included in a display device 1 of FIG. 1. FIG. 14 is a timing diagram illustrating periods during which a driving controller 200B of FIG. 13 is driven.

Referring to FIG. 1, FIG. 2, FIG. 13 and FIG. 14, a driving controller 200B may include a clock signal outputter 210B, a power controller 220B and an integrated pixel compensator 230B.

The clock signal outputter 210B may output an integrated clock signal group TCLKG in response to an integrated clock request signal RTS.

The power controller 220B may output an integrated power signal TPO in response to an integrated power request signal EPS.

The integrated pixel compensator 230B may perform the compensation operation for the first sub-pixel PU-SPX based on the input control signal CONT, the integrated clock signal group TCLKG and the integrated power signal TPO. Additionally, the integrated pixel compensator 230B may perform the compensation operation for the second sub-pixel PR-SPX based on the integrated clock signal group TCLKG and the integrated power signal TPO. The integrated pixel compensator 230B may output the public pixel data signal PUCS and the private pixel data signa PRCS.

Periods during which the driving controller 200B is driven may include first to third periods TP1C, TP2C and TP3C.

In the first period TP1C, the vertical synchronizing signal VSYNC may have an activation level, the enable signal EN may have an inactivation level, the data enable signal DE may have an activation level, and the flag signal FG may have an inactivation level. Accordingly, in the first period TP1C, the public pixel data signal PUCS may be generated. However, in the first period TP1C, the private pixel data signal PRCS may not be generated.

In the second period TP2C, the vertical synchronizing signal VSYNC may have an activation level, the enable signal EN may have an activation level, the data enable signal DE may have an activation level, and the flag signal FG may have an activation level. The second period TP2C may include a first sub-period SP1C and a second sub-period SP2C. In the first sub-period SP1C, the data enable signal DE may have an activation level, and the flag signal FG may have an inactivation level. Accordingly, in the first sub-period SP1C, the public pixel data signal PUCS may be generated but the private pixel data signal PRCS may not be generated. In the second sub-period SP2C, the data enable signal DE may have an activation level, and the flag signal FG may have an activation level. Accordingly, in the second sub-period SP2C, not only the public pixel data signal PUCS but also the private pixel data signal PRCS may be generated. Through the first sub-period SP1C and the second sub-period SP2C, the first sub-pixel PU-SPX and the second sub-pixel PR-SPX may be driven in a time division manner.

In the third period TP3C, the vertical synchronizing signal VSYNC may have an activation level, the enable signal EN may have an inactivation level, the data enable signal DE may have an activation level, and the flag signal FG may have an inactivation level. Accordingly, the public pixel data signal PUCS may be generated. However, in the third period TP3C, a generation of the private pixel data signal PRCS may be stopped.

In an embodiment of the present inventive concept, the public pixel data signal PUCS and the private pixel data signal PRCS may be generated based on the integrated clock signal group TCLKG and the integrated power signal TPO. Accordingly, the number of clock signals and the number of power signals for generating the public pixel data signal PUCS and the private pixel data signal PRCS may be reduced. Accordingly, a power consumption of the display device 1 may be reduced.

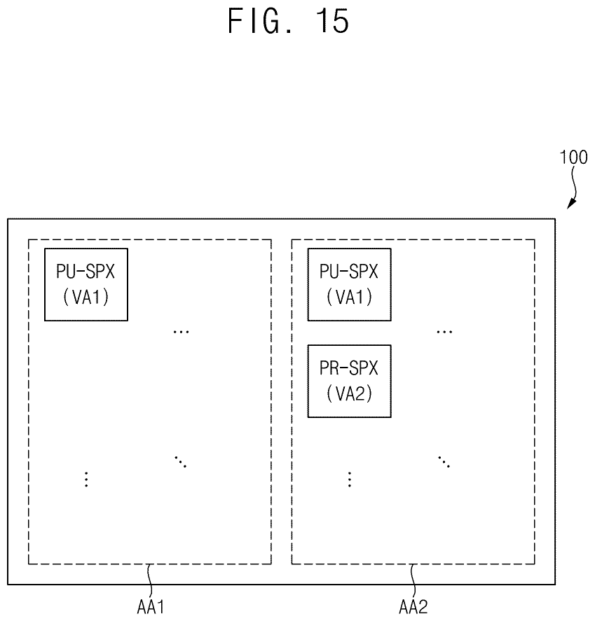

FIG. 15 is a diagram illustrating a display panel 100 included in a display device 1 of FIG. 1.

Referring to FIG. 1 to FIG. 15, the display panel 100 may include a first display region AA1 and a second display region AA2.

The first display region AA1 may include the first sub-pixel PU-SPX. For example, the first display region AA1 may not include the second sub-pixel PR-SPX. The second display region AA2 may include the first sub-pixel PU-SPX and the second sub-pixel PR-SPX. However, the present inventive concept is not limited to the number of display regions included in the display panel 100. For example, the display panel 100 may further include a third display region. The third display region may include the first sub-pixel PU-SPX, and may not include the second sub-pixel PR-SPX.

The display panel 100 according to an embodiment of the present inventive concept may be driven in a first mode or a second mode.

When the display panel 100 is driven in the first mode, the first sub-pixel PU-SPX of the first display region AA1 and the first sub-pixel PU-SPX of the second display region AA2 may emit light. In the first mode, the second sub-pixel PR-SPX of the second display region AA2 may not be driven and the second sub-pixel PR-SPX of the second display region AA2 may not emit light. When the display panel 100 is driven in the first mode, the second clock signal group CLKG2 may maintain a DC voltage to have an inactivation level. When the display panel 100 is driven in the first mode, the second power signal PO2 may have an inactivation level.

When the display panel 100 is driven in the second mode, not only the first sub-pixel PU-SPX of the first display region AA1 but also the second sub-pixel PR-SPX of the second display region AA2 may emit light. In the second mode, the first sub-pixel PU-SPX of the second display region AA2 may not emit light. When the display panel 100 is driven in the second mode, the second clock signal group CLKG2 may toggle. When the display panel 100 is driven in the second mode, the second power signal PO2 may have an activation level.

FIG. 16 is a block diagram illustrating an electronic device 1000 according to an embodiment of the present inventive concept. FIG. 17 is a diagram illustrating an example in which the electronic device of FIG. 16 is implemented as an automotive electronic device.

Referring to FIG. 16, the electronic device 1000 may include a processor 1010, a memory device 1020, a storage device 1030, an input/output (I/O) device 1040, a power supply 1050, and a display device 1060. Here, the display device 1060 may be the display device 1 of FIG. 1. Additionally, the electronic device 1000 may further include a plurality of ports for communicating with a video card, a sound card, a memory card, a universal serial bus (USB) device, other electronic device, etc.

In an embodiment, as illustrated in FIG. 17, the electronic device 1000 according to an embodiment may be implemented as an automotive electronic device.

Referring to FIG. 1 to FIG. 17, the electronic device 1000 may include a first display panel 100-1, a second display panel 100-2 and a third display panel 100-3. The first display panel 100-1 may include the first sub-pixel PU-SPX. For example, the first display panel 100-1 may include only the first sub-pixel PU-SPX, and may not include the second sub-pixel PR-SPX. The second display panel 100-2 may include the first sub-pixel PU-SPX. For example, the second display panel 100-2 may include only the first sub-pixel PU-SPX, and may not include the second sub-pixel PR-SPX. The third display panel 100-3 may include the first sub-pixel PU-SPX and the second sub-pixel PR-SPX.

However, the electronic device 1000 according to an embodiment is not limited thereto. For example, the electronic device 1000 may be implemented as a cellular phone, a video phone, a smart pad, a smart watch, a tablet PC, a car navigation system, a computer monitor, a laptop, a head mounted display (HMD) device, and the like.

The processor 1010 may perform various computing functions or various tasks. The processor 1010 may be a micro-processor, a central processing unit (CPU), an application processor (AP), and the like. The processor 1010 may be coupled to other components via an address bus, a control bus, a data bus, etc. Further, the processor 1010 may be coupled to an extended bus such as a peripheral component interconnection (PCI) bus.

The processor 1010 may output the input image data IMG and the input control signal CONT to the driving controller 200 of FIG. 1.

The memory device 1020 may store data for operations of the electronic device 1000. For example, the memory device 1020 may include at least one non-volatile memory device such as an erasable programmable read-only memory (EPROM) device, an electrically erasable programmable read-only memory (EEPROM) device, a flash memory device, a phase change random access memory (PRAM) device, a resistance random access memory (RRAM) device, a nano floating gate memory (NFGM) device, a polymer random access memory (PoRAM) device, a magnetic random access memory (MRAM) device, a ferroelectric random access memory (FRAM) device, and the like and/or at least one volatile memory device such as a dynamic random access memory (DRAM) device, a static random access memory (SRAM) device, a mobile DRAM device, and the like.

The storage device 1030 may include a solid state drive (SSD) device, a hard disk drive (HDD) device, a CD-ROM device, and the like. The I/O device 1040 may include an input device such as a keyboard, a keypad, a mouse device, a touch-pad, a touch-screen, and the like and an output device such as a printer, a speaker, and the like. In some embodiments, the display device 1060 may be included in the I/O device 1040. The power supply 1050 may provide power for operations of the electronic device 1000. The display device 1060 may be coupled to other components via the buses or other communication links.

Although FIG. 17 illustrates an embodiment of an electronic device implemented as the automotive electronic device, the present inventive concept is not limited thereto. The electronic device according to the present inventive concept may be a television, a monitor, a laptop computer, or a tablet. Additionally, the electronic device may be a car.

The display device according to embodiments of the present inventive concept may be applied to a display device included in a computer, a notebook, a mobile phone, a smart phone, a smart pad, a PMP, a PDA, an MP3 player, or the like.

The foregoing is illustrative of the present inventive concept and is not to be construed as limiting thereof. Although a few embodiments of the present inventive concept have been described, those skilled in the art will readily appreciate that many modifications are possible in the embodiments without materially departing from the novel teachings and advantages of the present inventive concept. Accordingly, all such modifications are intended to be included within the scope of the present inventive concept as defined in the claims. In the claims, means-plus-function clauses are intended to cover the structures described herein as performing the recited function and not only structural equivalents but also equivalent structures. Therefore, it is to be understood that the foregoing is illustrative of the present inventive concept and is not to be construed as limited to the specific embodiments disclosed, and that modifications to the disclosed embodiments, as well as other embodiments, are intended to be included within the scope of the appended claims. The present inventive concept is defined by the following claims, with equivalents of the claims to be included therein.

What is claimed is:

1. A display device comprising:
a display panel including a plurality of pixels; and
a display panel driver configured to drive the display panel,
wherein the plurality of pixels includes a first sub-pixel having a first viewing angle, and a second sub-pixel having a second viewing angle different from the first viewing angle,
wherein the first sub-pixel emits light based on a first sub-pixel compensation signal, and the second sub-pixel emits light based on a second sub-pixel compensation signal,
wherein the first sub-pixel compensation signal is generated based on a first clock signal group, and the second sub-pixel compensation signal is generated based on a second clock signal group, and
wherein when the first sub-pixel emits light, the second clock signal group maintains an inactivation level.

2. The display device of claim 1, wherein the display panel driver includes:
a clock signal outputter configured to output the first clock signal group and the second clock signal group;
a pixel compensator configured to output the first sub-pixel compensation signal and the second sub-pixel compensation signal based on an enable signal; and
a power controller configured to apply a power signal to the pixel compensator.

3. The display device of claim 2, wherein when the enable signal has an inactivation level, the pixel compensator outputs the first sub-pixel compensation signal, and does not output the second sub-pixel compensation signal.

4. The display device of claim 3, wherein when the enable signal has the inactivation level, the first clock signal group toggles, and the second clock signal group maintains the inactivation level.

5. The display device of claim 3, wherein the pixel compensator includes:
a first pixel compensator configured to output the first sub-pixel compensation signal; and
a second pixel compensator configured to output the second sub-pixel compensation signal,
wherein the power signal includes a first power signal applied to the first pixel compensator and a second power signal applied to the second pixel compensator, and
wherein when the enable signal has the inactivation level, the first power signal is applied to the first pixel compensator, and the second power signal is not applied to the second pixel compensator.

6. The display device of claim 3, wherein when the enable signal has an activation level, the first clock signal group toggles, and the second clock signal group toggles.

7. The display device of claim 3, wherein the pixel compensator includes:
a first pixel compensator configured to output the first sub-pixel compensation signal; and
a second pixel compensator configured to output the second sub-pixel compensation signal,
wherein the power signal includes a first power signal applied to the first pixel compensator and a second power signal applied to the second pixel compensator, and
wherein when the enable signal has an activation level, the first power signal is applied to the first pixel compensator, and the second power signal is applied to the second pixel compensator.

8. The display device of claim 2, wherein a first activation period in which the first clock signal group toggles does not overlap a second activation period in which the second clock signal group toggles.

9. The display device of claim 8, wherein in the first activation period, the second clock signal group maintains the inactivation level.

10. The display device of claim 2, wherein the pixel compensator includes:
a first pixel compensator configured to output the first sub-pixel compensation signal; and
a second pixel compensator configured to output the second sub-pixel compensation signal,
wherein the second pixel compensator includes:
a second pixel compensation signal outputter configured to output the second sub-pixel compensation signal; and
a second pixel compensation data memory configured to apply second pixel compensation data to the second pixel compensation signal outputter, and
wherein the second pixel compensation signal outputter includes a retention flip-flop performing a data retention.

11. The display device of claim 1, wherein a frame period in which the display panel is driven includes a first frame period and a second frame period,
wherein the first frame period includes a first active period and a first blank period,
wherein the second frame period includes a second active period and a second blank period longer than the first blank period, and
wherein in the second blank period, the first clock signal group and the second clock signal group maintain the inactivation level.

12. A display device comprising:
a display panel including a first display region and a second display region; and
a display panel driver configured to drive the display panel,
wherein the first display region includes a first sub-pixel having a first viewing angle,
wherein the second display region includes the first sub-pixel and a second sub-pixel having a second viewing angle different from the first viewing angle,
wherein the first sub-pixel emits light based on a first data signal, and the second sub-pixel emits light based on a second data signal,
wherein the first data signal is generated based on a first sub-pixel compensation signal, and the second data signal is generated based on a second sub-pixel compensation signal,
wherein the first sub-pixel compensation signal is generated based on a first clock signal group, and the second sub-pixel compensation signal is generated based on a second clock signal group, and
wherein when the first sub-pixel of the second display region emits light, the second clock signal group maintains the inactivation level.

13. The display device of claim 12, wherein the display panel driver includes:
a clock signal outputter configured to output the first clock signal group and the second clock signal group;
a pixel compensator configured to output the first sub-pixel compensation signal and the second sub-pixel compensation signal based on an enable signal; and
a power controller configured to apply a power signal to the pixel compensator.

14. The display device of claim 13, wherein when the enable signal has an inactivation level, the first clock signal group toggles, and the second clock signal group maintains the inactivation level.

15. The display device of claim 13, wherein when the enable signal has an activation level, the first clock signal group toggles, and the second clock signal group toggles.

16. The display device of claim 12, wherein the display panel is driven in a first mode or a second mode,
wherein in the first mode, the first sub-pixel of the second display region emits light, and the second sub-pixel of the second display region does not emit light, and
wherein in the second mode, the first sub-pixel of the second display region does not emit light, and the second sub-pixel of the second display region emits light.

17. The display device of claim 16, wherein when the display panel is driven in the first mode, the second clock signal group maintains the inactivation level.

18. The display device of claim 16, wherein when the display panel is driven in the first mode, a second power signal applied to a second sub-pixel compensator which outputs the second sub-pixel compensation signal has an inactivation level.

19. An electronic device comprising:
a processor configured to output input image data and an input control signal;
a display panel including a plurality of pixels; and
a display panel driver configured to drive the display panel based on the input image data and the input control signal,
wherein the plurality of pixels includes a first sub-pixel having a first viewing angle, and a second sub-pixel having a second viewing angle different from the first viewing angle
wherein the first sub-pixel emits light based on a first sub-pixel compensation signal, and the second sub-pixel emits light based on a second sub-pixel compensation signal,
wherein the first sub-pixel compensation signal is generated based on a first clock signal group, and the second sub-pixel compensation signal is generated based on a second clock signal group, and
wherein when the first sub-pixel emits light, the second clock signal group maintains an inactivation level.

20. The electronic device of claim 19, wherein the display panel includes a first display region and a second display region,
wherein the first display region includes the first sub-pixel, and the second display region includes the first sub-pixel and the second sub-pixel, and
wherein when the first sub-pixel of the second display region emits light, the second clock signal group maintains the inactivation level.
